(19) United States
(12) Patent Application Publication
(10) Pub. No.: US 2012/0064851 A1
(43) Pub. Date: Mar. 15, 2012

(54) WIRELESS SIGNAL CONVERSION SYSTEM

(76) Inventor: Gary WANG, Taoyuan County (TW)

(21) Appl. No.: 12/879,705

(22) Filed: Sep. 10, 2010

(51) Int. Cl. H04B 1/10; H04B 1/16

(52) U.S. Cl. 455/311; 455/334; 455/341

(57) ABSTRACT

A wireless signal conversion system includes a conversion output apparatus and at least one conversion input apparatus. The conversion output apparatus receives a wireless signal via an antenna, and feeds signal data carried by the wireless signal into a power line. The conversion input apparatus retrieves the signal data from the power line and then provides the signal data to an electronic device.

### FIELD OF THE INVENTION

The present invention relates to communication signal conversion apparatuses, and more particularly, to a wireless signal conversion system for feeding signal data of wireless signals into a power line.

### BACKGROUND OF THE INVENTION

Wireless communication technology nowadays is sophisticated. Most household electronic devices receive or transmit wireless signals with an antenna. However, coverage of wireless networks cannot be unlimited and thereby is not absolutely free from dead space. Also, excessive electromagnetic waves are harmful to the human body. Thus, in addition to wireless communication, household electronic devices can receive or transmit signal data, using a power line.

With power line-based communication technology growing and developing, power lines are becoming more versatile. A power line is a means of supplying power to electronic devices, a conduit whereby household electronic devices receive signal data, and an alternative way of processing and storing the signal data.

Accordingly, it is imperative for the industrial sector and researchers to integrate an existing wireless communication network and a power line-based communication network so as to minimize the negative effect of electromagnetic waves on the human body and solve the problems with dead space.

### SUMMARY OF THE INVENTION

The present invention provides a wireless signal conversion system comprising a conversion output apparatus and at least one conversion input apparatus. The conversion output apparatus receives wireless signals through an antenna and feeds signal data carried by wireless signals into a power line. The conversion input apparatus retrieves the signal data from the power line, and provides the signal data to an electronic device.

The present invention further provides a conversion output apparatus comprising a capacitor, an adapting circuit, and an isolating circuit. The capacitor has a first end and a second end. The first end receives wireless signals from an antenna. The adapting circuit has an adapting circuit input end and an adapting circuit output end. The adapting circuit input end is coupled to the second end of the capacitor. The isolating circuit has an isolating circuit input end and an isolating circuit output end. The isolating circuit input end is coupled to the adapting circuit output end. The isolating circuit output end is coupled to a power line. The signal data of the wireless signals are fed into the power line through the adapting circuit and the isolating circuit.

The present invention further provides a conversion input apparatus comprising an isolating circuit, an adapting circuit, and a capacitor. The isolating circuit has an isolating circuit input end and an isolating circuit output end. The isolating circuit input end is coupled to a power line. The adapting circuit has an adapting circuit input end and an adapting circuit output end. The adapting circuit input end is coupled to the isolating circuit output end. The capacitor has a first end and a second end. The first end is coupled to the adapting circuit output end. The second end is coupled to an electronic device. The conversion input apparatus retrieves signal data from the power line through the adapting circuit and the isolating circuit.

In short, the present invention relates to communication techniques of converting wireless signals into wired signals for transmission. The present invention has advantages as follows: (1) feeding most of the wireless signals into the power line; (2) minimizing the dead space of the power line-based communication and dispensing with the need for additional wire layout; (3) enabling electronic devices to share signal data concurrently without relying upon any distributor; (4) converting wireless signals into wired signals to thereby minimize the negative effect of electromagnetic waves on the human body; and (5) enabling power filtration, mitigating the damage caused to household electronic devices by surge, thereby extending the service life of household electronic devices.

### BRIEF DESCRIPTION OF THE DRAWINGS

FIG. 1 is a schematic view of a wireless signal conversion system in a preferred embodiment according to the present invention;

FIG. 2 is a schematic view of a conversion output apparatus in a preferred embodiment according to the present invention; and

FIG. 3 is a schematic view of a conversion input apparatus in a preferred embodiment according to the present invention.

### DETAILED DESCRIPTION OF THE PREFERRED EMBODIMENTS

To minimize the negative effect of electromagnetic waves on the human body, the present invention provides a wireless signal conversion system whereby signal data of wireless signals are fed into a power line by carrier conversion, so as for the signal data to be steadily, clearly received by back-end household electronic devices. In this regard, alternatives to the aforesaid household electronic devices include office electronic devices and industrial electronic devices, as the aforesaid electronic devices are not limited to the disclosure contained in the specification of the present invention. For examples, the aforesaid electronic devices are smart electric appliances, smart all-in-one office machine, industrial machines/devices, or computation devices.

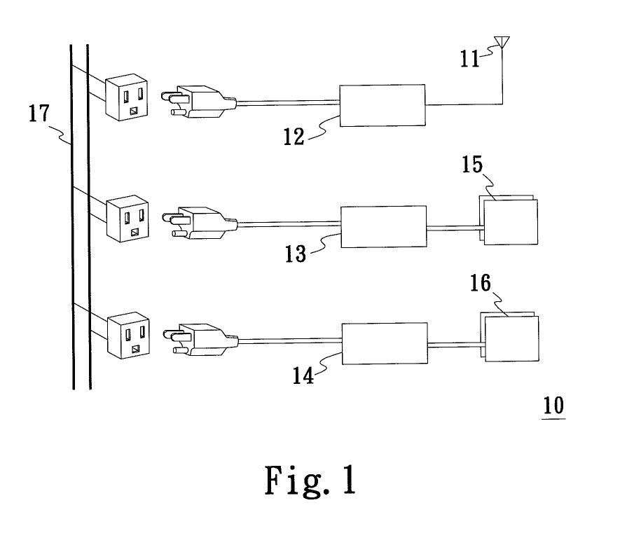

Referring to FIG. 1, there is shown a schematic view of a wireless signal conversion system in a preferred embodiment according to the present invention. As shown in the drawing, a wireless signal conversion system 10 comprises a conversion output apparatus 12 and conversion input apparatuses 13, 14. An antenna 11 is either part of the conversion output apparatus 12 or separate therefrom. The antenna 11 receives, from a wireless channel, wireless signals in the RF frequency band. The RF wireless signals thus received undergo a conversion process in the conversion output apparatus 12. Then, signal data of wireless signals are fed, through a plug and a socket, into a power line 17 serving a household purpose. When the plugs of a plurality of electronic devices 15, 16 are inserted into the sockets of the power line 17 serving a household purpose, the signal data are retrieved by conversion through the conversion input apparatuses 13, 14. The signal data thus retrieved are shared by the electronic devices 15, 16 concurrently.

Although the aforesaid embodiment is exemplified by the reception of RF wireless signals with the antenna 11, the present invention is not limited thereto. In other embodiments of the present invention, the antenna 11 is configured to receive wireless signals of other frequencies. Likewise, although the aforesaid embodiment is exemplified by the power line 17 serving a household purpose, the present invention is not limited thereto. In other embodiments of the present invention, the power line 17 is an industrial power line or the like. In short, the conversion output apparatus 12 receives wireless signals through the antenna 11 and then feeds signal data carried by wireless signals into the power line 17. The conversion input apparatuses 13, 14 retrieve the signal data from the power line 17. The signal data thus retrieved are provided to the electronic devices 15, 16.

Furthermore, the conversion output apparatus 12 performs an interference noise suppressing process on wireless signals and then amplifying the wireless signals. However, in the situation where there is little interference noise, the conversion output apparatus 12 feeds signal data of wireless signals into the power line directly, without performing the interference noise suppressing process or amplifying the wireless signals. In addition, the conversion input apparatuses 13, 14 perform high-pass filtration on signal data retrieved from the power line and then amplifying the signal data. However, in the situation where there is little interference noise, the conversion input apparatuses 13, 14 provide signal data retrieved from the power line to the electronic devices 15, 16 directly, without performing high-pass filtration on the signal data or amplifying the signal data.

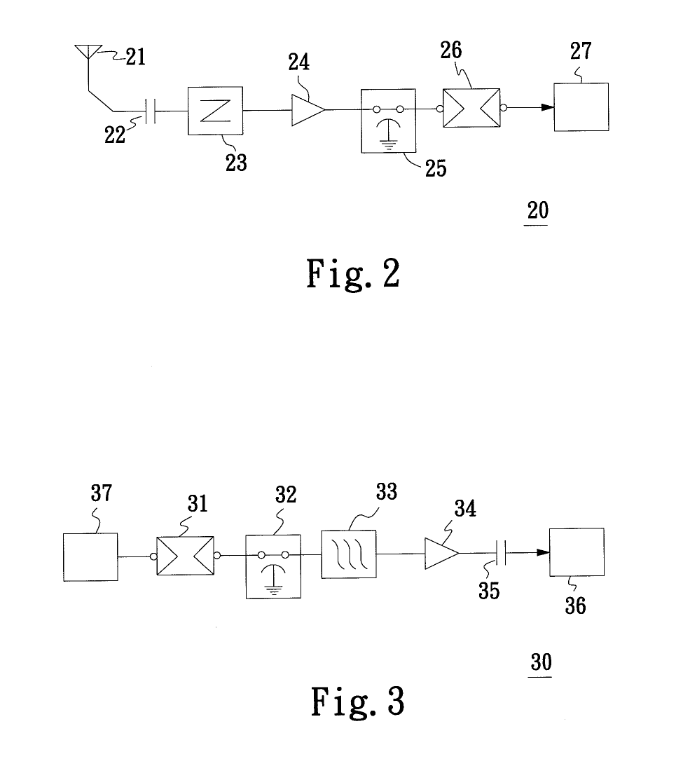

Referring to FIG. 2, there is shown a schematic view of a conversion output apparatus in a preferred embodiment according to the present invention. As shown in the drawing, a conversion output apparatus 20 comprises a capacitor 22, an adapting circuit 25, and an isolating circuit 26. The capacitor 22 has a first end and a second end. The first end of the capacitor 22 receives wireless signals from an antenna 21. The adapting circuit 25 has an adapting circuit input end and an adapting circuit output end. The adapting circuit input end is coupled to the second end of the capacitor 22. The isolating circuit 26 has an isolating circuit input end and an isolating circuit output end. The isolating circuit input end is coupled to the adapting circuit output end. The isolating circuit output end is coupled to a power line 27 serving a household purpose. With the adapting circuit 25 and the isolating circuit 26, signal data of wireless signals are fed into the power line 27 serving a household purpose. The capacitor 22 filters out the direct current component and the low-frequency component of wireless signals.

With reception efficiency in mind, it is imperative to perform an interference noise suppressing process on wireless signals and then amplifying the wireless signals. Accordingly, the conversion output apparatus 20 further comprises a suppressing circuit 23 and an amplifying circuit 24. The suppressing circuit 23 has a suppressing circuit input end and a suppressing circuit output end. The suppressing circuit input end is coupled to the second end of the capacitor 22. The suppressing circuit 23 performs the interference noise suppressing process on wireless signals. The amplifying circuit 24 has an amplifying circuit input end and an amplifying circuit output end. The amplifying circuit input end is coupled to the suppressing circuit output end. The amplifying circuit output end is coupled to the adapting circuit input end. The amplifying circuit 24 amplifies wireless signals. The adapting circuit input end is coupled to the second end of the capacitor 22 via the suppressing circuit 23 and the amplifying circuit 24.

In addition, the conversion output apparatus 20 further comprises, optionally, the antenna 21. The antenna 21 is coupled to the first end of the capacitor 22 and configured to receive, from a wireless channel, wireless signals in the RF frequency band.

Referring to FIG. 3, there is shown a schematic view of a conversion input apparatus in a preferred embodiment according to the present invention. As shown in the drawing, a conversion input apparatus 30 comprises an isolating circuit 31, an adapting circuit 32, and a capacitor 35. The isolating circuit 31 has an isolating circuit input end and an isolating circuit output end. The isolating circuit input end is coupled to a power line 37 serving a household purpose. The adapting circuit 32 has an adapting circuit input end and an adapting circuit output end. The adapting circuit input end is coupled to the isolating circuit output end. The capacitor 35 has a first end and a second end. The first end of the capacitor 35 is coupled to the adapting circuit output end. The second end of the capacitor 35 is coupled to an electronic device 36. The conversion input apparatus 30 retrieves signal data from the power line 37 by means of the isolating circuit 31 and the adapting circuit 32. The purpose of the capacitor 35 filters out the direct current component and the low-frequency component of the signal data.

To meet expectations for reception efficiency, it may be necessary to perform a high-pass filtration process on the signal data retrieved from the power line 37 serving a household purpose and then amplify the signal data. Thus, the conversion input apparatus 30 further comprises a high-pass filtering circuit 33 and an amplifying circuit 34. The high-pass filtering circuit 33 has a high-pass filtering circuit input end and a high-pass filtering circuit output end. The high-pass filtering circuit input end is coupled to the adapting circuit output end. The high-pass filtering circuit 33 is configured to perform a high-pass filtration process on the signal data. The amplifying circuit 34 has an amplifying circuit input end and an amplifying circuit output end. The amplifying circuit input end is coupled to the high-pass filtering circuit output end. The amplifying circuit output end is coupled to the first end of the capacitor 35. The amplifying circuit 34 amplifies the signal data. The first end of the capacitor 35 is coupled to the adapting circuit output end via the amplifying circuit 34 and the high-pass filtering circuit 33.

As illustrated with the above embodiments, the present invention relates to communication techniques for converting wireless signals into wired signals for transmission. The present invention has advantages as follows: (1) feeding most of the wireless signals into the power line; (2) minimizing the dead space of the power line-based communication and dispensing with the need for additional wire layout; (3) enabling electronic devices to share signal data concurrently without relying upon any distributor; (4) converting wireless signals into wired signals to thereby minimize the negative effect of electromagnetic waves on the human body; and (5) enabling power filtration, mitigating the damage caused to household electronic devices by surge, thereby extending the service life of household electronic devices.

What is claimed is:

1. A wireless signal conversion system, comprising:
a conversion output apparatus for receiving a wireless signal through an antenna and feeding signal data carried by the wireless signal into a power line; and
at least a conversion input apparatus for retrieving the signal data from the power line and providing the signal data to an electronic device.

2. The wireless signal conversion system of claim 1, wherein the conversion output apparatus performs an interference noise suppressing process on the wireless signals and then amplifies the wireless signals.

3. The wireless signal conversion system of claim 1, wherein the conversion output apparatus comprises:
a capacitor having a first end and a second end, the first end receiving the wireless signals from the antenna;
an adapting circuit having an adapting circuit input end and an adapting circuit output end, the adapting circuit input end being coupled to the second end of the capacitor; and
an isolating circuit having an isolating circuit input end and an isolating circuit output end, the isolating circuit input end being coupled to the adapting circuit output end, and the isolating circuit output end being coupled to the power line,
wherein the signal data of the wireless signals are fed into the power line by means of the adapting circuit and the isolating circuit.

4. The wireless signal conversion system of claim 1, wherein the conversion input apparatus performs a high-pass filtration process on the signal data retrieved from the power line and then amplifies the signal data.

5. The wireless signal conversion system of claim 1, wherein the conversion input apparatus comprises:
an isolating circuit having an isolating circuit input end and an isolating circuit output end, the isolating circuit input end being coupled to the power line;
an adapting circuit having an adapting circuit input end and an adapting circuit output end, the adapting circuit input end being coupled to the isolating circuit output end; and
a capacitor having a first end and a second end, the first end being coupled to the adapting circuit output end, and the second end being coupled to the electronic device,
wherein the signal data are retrieved from the power line by means of the adapting circuit and the isolating circuit.
